(19) United States
(12) Patent Application Publication
(10) Pub. No.: US 2024/0194083 A1
(43) Pub. Date: Jun. 13, 2024

(54) AUTOMATIC ADAPTATION OF THE VERTICAL PROFILE OF AN AIRCRAFT ON THE BASIS OF A POSITIONAL UNCERTAINTY

(71) Applicant: THALES, MEUDON (FR)

(72) Inventor: Marc RIEDINGER, TOULOUSE (FR)

(21) Appl. No.: 18/286,348

(22) PCT Filed: Apr. 12, 2022
(86) PCT No.: PCT/EP2022/059806

§ 371 Date: Oct. 10, 2023

(30) Foreign Application Priority Data
Apr. 14, 2021 (FR) 2103857

(51) Int. Cl. G08G 5/04; G06V 10/80; G08G 5/00

(52) U.S. Cl. CPC G08G 5/045; G06V 10/803; G08G 5/006; G08G 5/0069; G08G 5/0086

(57) ABSTRACT

A method allowing an aircraft to follow a lateral path with a determined safety level. The method consists in determining a 3D corridor around a predicted path of the aircraft, based on at least one computed safety distance. If the safety corridor conflicts with at least one obstacle in a terrain and obstacle database, the vertical flight profile of the aircraft is modified in order to increase the altitude of the aircraft, to avoid obstacles while keeping lateral path constant.

### CROSS-REFERENCE TO RELATED APPLICATIONS

This application is a National Stage of International patent application PCT/EP2022/059806, filed on Apr. 12, 2022, which claims priority to foreign French patent application No. FR 2103857, filed on Apr. 14, 2021, the disclosures of which are incorporated by reference in their entireties.

### FIELD OF THE INVENTION

The field of the invention relates to avionics in general, and to adaptation of the vertical flight profile of an aircraft in particular.

### BACKGROUND

Current air navigation regulations distinguish between multiple navigation categories. The first category is that referred to as “conventional” navigation, the oldest one: it involves using radio beacons to navigate from beacon to beacon. The second category relates to what is referred to as PBN navigation, which consists in using sensors to determine an airplane position and using this position to guide the airplane along a route defined based on waypoints. This type of navigation requires a computation of an uncertainty (referred to as the 95% probability EPU) to be associated with the computation of position.

PBN navigation itself is split into two distinct navigation concepts: 1) RNAV navigation: a route is defined with an associated accuracy performance level. Thus, for an RNAV 10 route, the navigation system is asked to automatically follow the route with a 95% probability accuracy of +/−10 nautical miles (nm); and 2) RNP navigation, which entails, in addition to the requirements of an RNAV route, on-board performance monitoring and alerting, which makes it possible to monitor whether the airplane remains in a corridor or containment generally of plus or minus (+/−) 2 times the RNP value around the route flown. It is generally associated with a probability of leaving the containment of 10\hat{ }-5/h.

The invention pertains to the field of RNP navigation. To be able to perform this type of navigation, it is necessary to compute a position and to statistically characterize performance in respect of positioning (for example through one or more indicators). A first example of an indicator consists in qualifying positioning accuracy through a 95% probability estimate of its error: EPU. This estimate is made assuming that there is no latent failure that could affect the computation of the position. Another example of an indicator allows positioning integrity to be qualified with a certain probability, through a protection radius around the computed position: HIL for a lateral position. An equivalent estimate, VIL, may be computed for altitude. This confidence estimate is computed assuming that there may be one or more latent failures affecting the measurements used, and takes into account the probability of occurrence of failures.

The principle of RNP navigation assumes use of a GNSS position, augmented by these two performance indicators. Implementation of RNP in airspaces is something that will be important in meeting the increasing needs of air traffic control.

Global navigation satellite systems, also referred to by the acronym GNSS, have in recent decades become common tools allowing air operations to be supported in all the phases of flight of an aircraft, with a high level of performance and integrity.

However, these systems are based on satellite signals that are weak and that are, above all, susceptible to interference or outages. GNSS service outages or interruptions remain a major concern in the industry. In order to generalize use of RNP, it is necessary to mitigate the risk of loss of the GNSS signal, and to consider whether or not it is possible to perform all or some of this navigation with backup systems in the event of GNSS signal loss.

In the field of civil aviation, deterioration or loss of the GNSS signal may be managed in a number of ways.

Firstly, the navigation accuracy required on an air route is generally of the order of one or more nautical miles. Thus, even in the event of signal deterioration, and therefore of increased positional uncertainty, RNP guidance may be maintained by the aircraft, at least in cruise phase.

Moreover, even if the signal is lost or, more generally, it is impossible to provide RNP navigation, the pilot of an airliner is able to initiate manual flight, and fly the aircraft in collaboration with air traffic control.

In addition to conventional aircraft categories, new aircraft categories are becoming increasingly popular. In particular, the use of drones is becoming more and more frequent. Drone navigation is of major economic interest, as drones allow new applications and new economic models to be unlocked. For example, drones may be used to deliver packages directly to customers.

Navigation of drones has a few differences with respect to conventional air navigation. Some of the most salient differences are:
while in some cases it may be flown by a remote operator, a drone is usually flown automatically;
the flight environment of a drone is different from the flight environment of an airliner: a drone generally flies at a lower altitude, and may be required to fly through an urban environment.

These differences mean that, for drones, GNSS-signal availability is more haphazard. Specifically, in an urban environment, the GNSS signal may be masked by buildings, notably tower blocks. When flying at low altitude, notably in urban environments, the GNSS signal may also be degraded through human intervention. For example, it may commonly be jammed by individuals who do not wish to be located, or more rarely corrupted by malicious actors.

In addition to a higher probability of signal loss or deterioration, these differences make the solutions used to navigate airliners in the event of loss or deterioration of the GNSS signal unusable in practice for drones.

Specifically, a drone flying in the immediate vicinity of a relief or buildings in an urban environment cannot tolerate a high uncertainty in its position. In addition, guidance of the drone cannot be transferred to a pilot in collaboration with air traffic control.

No prior-art solution therefore allows a drone to follow a lateral path in an environment in which the GNSS signal may be degraded, while guaranteeing a level of safety with respect to obstacles. The same problem more generally arises whenever an aircraft must be navigated automatically, without possible recourse to manual navigation, and when the GNSS signal may become degraded.

There is therefore a need for a solution allowing an aircraft to automatically perform RNP navigation along a lateral path, in an environment in which the GNSS signal may become degraded.

### SUMMARY OF THE INVENTION

To this end, one subject of the invention is a method implemented by a computer located on board an aircraft, comprising: obtaining an estimated 3D position of the aircraft, at least one safety distance defining, around the estimated position of the aircraft, a zone within which the actual position of the aircraft is located with a probability equal to or higher than a predefined threshold, a lateral path of the aircraft, a vertical flight profile of the aircraft, and a terrain and obstacle database; determining a 3D flight corridor of the aircraft, taking into account the at least one safety distance around the lateral path and vertical profile; projecting said 3D corridor onto the terrain and obstacle database; verifying existence of a conflict between the 3D corridor and at least one obstacle of the terrain and obstacle database; if a conflict exists, modifying the vertical profile to increase the altitude of the aircraft at the location of said conflict; guiding the aircraft according to the lateral path and the vertical profile.

Advantageously, the estimated position of the aircraft, and the at least one distance are obtained via fusion of multi-sensor data from a plurality of sensors of the aircraft.

Advantageously, the fusion of multi-sensor data employs a Kalman filter.

Advantageously, the at least one safety distance comprises a lateral safety distance, and a vertical safety distance.

Advantageously, determining the 3D corridor consists in predicting a 3D path of the aircraft based on the lateral path and on the vertical profile, and then in successively adding each of the lateral and vertical safety distances to the 3D path.

Advantageously, determining the 3D corridor consists in predicting a 3D path of the aircraft based on the lateral path and on the vertical profile, defining a safety ellipse based on the lateral and vertical safety distances, then in adding the safety ellipse to the 3D path.

Advantageously, modifying the vertical profile consists in increasing the altitude of the aircraft by an altitude difference (8H) between the altitude of the at least one obstacle and the minimum altitude of the 3D corridor at the location of said conflict.

Another subject of the invention is a computer program comprising program-code instructions stored on a computer-readable medium, said program-code instructions being configured, when said program is run on a computer, to execute a method according to one of the embodiments of the invention.

Another subject of the invention is a flight management system for an aircraft, comprising computing means configured to execute a method according to one of the embodiments of the invention.

### BRIEF DESCRIPTION OF THE DRAWINGS

Other features, details and advantages of the invention will become apparent on reading the description given with reference to the appended drawings, which are given by way of example, and which show, respectively:

FIG. 1 one example of an FMS in which the invention may be implemented;

FIG. 2 a plurality of entities used by a computer-implemented method according to one set of embodiments of the invention;

FIG. 3 one example of a computer-implemented method according to one set of embodiments of the invention;

FIG. 4a one example of a 3D safety corridor, in one set of modes of implementation of the invention;

FIG. 4b one example of increase in the size of a 3D safety corridor, following deterioration of a GNSS signal according to one set of embodiments of the invention;

FIG. 4c one example of achieving safety through modification of a 3D safety corridor, by modifying a vertical flight profile, in one set of embodiments of the invention.

### DETAILED DESCRIPTION

Some acronyms commonly used in the technical field of the present patent application may be used in the description. These acronyms are listed in the table below, with notably the corresponding expression and the meaning thereof.

TABLE 1

| Acronym | Expression | Meaning |
|---|---|---|
| DB | Database | A container allowing complete information |
| | | related to an activity to be stored and retrieved. |
| | | Generally takes computerized form. |
| EPU | Estimated Position | EPU defines a horizontal distance around the |
| | Uncertainty | estimated position of the aircraft, defining a |
| | | zone within which the aircraft has a probability |
| | | of being located equal to a predefined threshold, |
| | | usually 95%. When this position is computed by |
| | | a positioning system of the aircraft using a |
| | | triangulation principle based on measurements |
| | | of radio-navigation signals emitted by beacons |
| | | the position of which is known, the value of the |
| | | EPU is dependent on the statistics of errors in |
| | | measurements of the signals, and on the |
| | | relative position of the measurements. |
| FPLN | Flight Plan | Description of the flight path to be followed by |
| | | the aircraft, and notably waypoints describing |
| | | the route thereof. |
| FMD | Flight Management | The FMD is a system for displaying data |
| | Display | supplied by an FMS. |
| FMS | Flight Management | Computerized system allowing aircraft paths |
| | System | and flight plans to be computed, and guidance |
| | | instructions tailored to the operator or autopilot |
| | | to be delivered so as to allow the computed |
| | | path to be followed. |
| FPA | Flight Path Angle | Angle made between a horizontal line and a line |
| | | tangent to the direction of flight of an aircraft. |
| GNSS | Global Navigation | A set of components based on a constellation of |
| | Satellite System | artificial satellites allowing a user to be provided, |
| | | via a small portable receiver, with their 3D |
| | | position, their 3D speed and the time. |
| GPS | Global Positioning | A satellite positioning system. |
| | System | |
| HIL | Horizontal Integrity | HIL defines the radius of a circle, around the |
| | Limit | current position computed by a positioning |
| | | system of the aircraft using measurements of |
| | | radio-navigation signals, within which it is |
| | | guaranteed that the true position of the aircraft |
| | | is located with a given probability, including in |
| | | the event of abnormal errors in the signals used, |
| | | said errors being due to the system that |
| | | generated them and having a higher probability |
| | | of occurrence than the desired probability. In the |
| | | context of positioning aircraft using GPS, |
| | | position integrity better than 1-10-7/h is generally |
| | | sought. |
| KCCU | Keyboard Console | This is a human-machine interface able to be |
| | Control Unit | integrated into a cockpit, and that comprises a |
| | | keyboard so that the operator may enter |
| | | information into the FMS. |
| MCDU | Multi-purpose | This is a human-machine interface able to be |
| | Control Display | integrated into a cockpit, and that allows many |
| | Unit | data items related to the FMS to be displayed |
| | | and input. |
| ND | Navigation Display | The ND is a cockpit display element that in |
| | | particular shows the lateral flight path. |
| PBN | Performance | PBN is a type of navigation consisting in using |
| | Based Navigation | sensors to determine an airplane position and |
| | | using this position to guide the airplane along a |
| | | RNAV route, while complying with a set of |
| | | criteria defining the accuracy and the fidelity |
| | | with which the route is followed. |
| RNAV | Area NAVigation | RNAV is an instrument flight method whereby |
| | | an aircraft is able to follow any path within a |
| | | network of waypoints on the ground without the |
| | | need for conventional radio-navigation beacons. |
| RNP | Required | This is a navigation requirement specifying the |
| | Navigation | 3D points accessible to an aircraft while flying a |
| | Performance | path. Generally, it consists of a distance |
| | | tolerance with respect to a set of 3D points |
| | | forming a predicted path. |
| VD | Vertical Display | This is a display element able to be integrated |
| | | into a cockpit, and that displays the reference |
| | | profile and the vertical profile that will allow the |
| | | aircraft to re-join the reference. |
| VEPU | Vertical Estimated | VEPU defines a horizontal distance around the |
| | Position | estimated altitude of the aircraft, defining an |
| | Uncertainty | altitude range within which the aircraft has a |
| | | probability of being located equal to a |
| | | predefined threshold, usually 95%. The value of |
| | | the VEPU is dependent on the statistics of |
| | | errors in measurements of the signals, and on |
| | | the relative position of the measurements. |
| VIL | Vertical Integrity | VIL defines a margin, around the current altitude |
| | Limit | computed by a positioning system of the |
| | | aircraft, within which it is guaranteed that the |
| | | true altitude of the aircraft is located with a given |
| | | probability, including in the event of abnormal |
| | | errors in the signals used, said errors being due |
| | | to the system that generated them and having a |
| | | higher probability of occurrence than the desired |
| | | probability. |

### DETAILED DESCRIPTION OF THE INVENTION

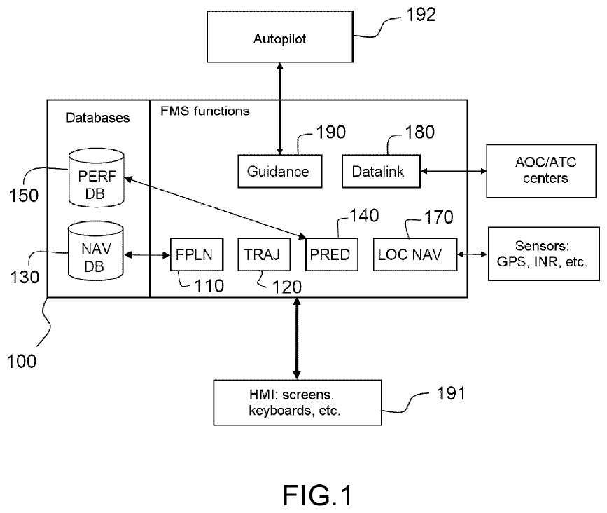

FIG. 1 shows one example of an FMS in which the invention may be implemented.

A flight management system may be implemented by at least one computer located on board an aircraft or in a ground station. According to various embodiments of the invention, it may be a flight management system of various types of aircraft, for example of an airplane, of a helicopter or of a drone.

The FMS 100 notably determines a geometry of a profile of a flight plan followed by the aircraft. The path is computed in four dimensions: three spatial dimensions and a time/speed-profile dimension. The FMS 100 also transmits, to the operator, via a first operator interface, or to the autopilot 192, guidance instructions, computed by the FMS 100, allowing the flight profile to be followed. The operator may be located in the aircraft, for example if the aircraft is an airplane or a helicopter, or indeed on the ground, for example if the aircraft is a drone.

A flight management system may comprise one or more databases such as the database PERF DB 150, and the database NAV DB 130. For example, the database PERF DB 150 may contain aerodynamic parameters of the aircraft, or indeed characteristics of the engines of the aircraft. It notably contains the performance margins systematically applied in the prior art to guarantee safety margins in the descent and approach phases. The database NAV DB 130 may for example contain the following elements: geographical points, beacons, air routes, departure procedures, arrival procedures, altitude constraints, speed constraints or slope constraints, etc.

Management of a flight plan according to the prior art may invoke means allowing the flight crew of the aircraft to create/modify a flight plan through one or more human-machine interfaces, for example:
the MCDU;
the KCCU;
the FMD;
the ND;
the VD.

This flight-plan creation/modification may for example comprise loading of procedures by the operator, and selection of a procedure to be added to the current flight plan.

The FMS 100 comprises a flight plan management module 110, usually denoted FPLN. The module FPLN 110 notably makes it possible to manage various geographical elements forming a skeleton of a route to be followed by the aircraft, comprising: a departure airport, waypoints, air routes to be followed, an arrival airport. The module FPLN 110 also makes it possible to manage various procedures forming part of a flight plan such as: a departure procedure, an arrival procedure. The capability FPLN 110 notably makes it possible to create, modify and delete a primary or secondary flight plan.

The flight plan and its various data items, which are notably related to the corresponding path computed by the FMS, may be displayed for consultation by the flight crew by display devices, also called human-machine interfaces, which are present in the cockpit of the aircraft, such as an FMD, an ND, or a VD.

The module FPLN 110 uses data stored in databases NAV DB 130 to construct a flight plan and the associated path.

The FMS 100 also comprises a module TRAJ 120 allowing a lateral path to be computed for the flight plan defined by the module FPLN 110. The module TRAJ 120 notably constructs a continuous path based on points of an initial flight plan, while respecting aircraft performance data supplied by the database PERF DB 150. The initial flight plan may be an active flight plan or a secondary flight plan. The continuous path may be presented to the operator by way of one of the human-machine interfaces.

The FMS 100 also comprises a path prediction module PRED 140. The module PRED 140 notably constructs an optimized vertical profile based on the lateral path of the aircraft, as supplied by the module TRAJ 120. To this end, the module PRED 140 uses the data of the first database PERF DB 150. The vertical profile may be presented to the operator by means of a VD, for example.

The FMS 100 also comprises a location module 170, denoted LOCNAV in FIG. 1. The module LOCNAV 170 notably determines an optimized geographical location of the aircraft, in real time, using geolocation means located on board the aircraft.

The FMS 100 also comprises a data link module 180, denoted DATA LINK in FIG. 1. The module DATA LINK 180 makes it possible to communicate with operators on the ground, for example in order to transmit a predicted path of the aircraft, or to receive path constraints, such as the predicted position of other aircraft or altitude constraints.

The FMS 100 also comprises a guidance module 190. The guidance module 190 notably delivers, to the autopilot 192 or to one of the human-machine interfaces 191, appropriate commands allowing the aircraft to be guided in lateral and vertical geographical planes (altitude and speed) so that said aircraft follows the path planned in the flight plan.

The guidance algorithms implement automations that take, as input, an active path or flight-plan element and the position measured by one or more sensors of the aircraft. These guidance instructions generally comprise a) a roll setpoint, a roll angular speed or a path segment for guidance in the horizontal plane; b) an attitude, an attitude delta, a pitch angular speed, a load factor, a vertical acceleration, a vertical speed, a slope, or a path segment in the vertical plane; c) a speed, an acceleration, a total energy, an engine setpoint, an objective in respect of time for the speed guidance.

The example of FIG. 1 shows an aircraft FMS 100 that allows interaction with a pilot located on board the aircraft. The invention may also be implemented in a flight management system of a drone. A flight management system of a drone is based on the same principles, but does not allow interaction with a pilot located on board the aircraft via interfaces 191. In the context of a drone, only transmission of guidance instructions to the autopilot 192 allows the drone to be guided.

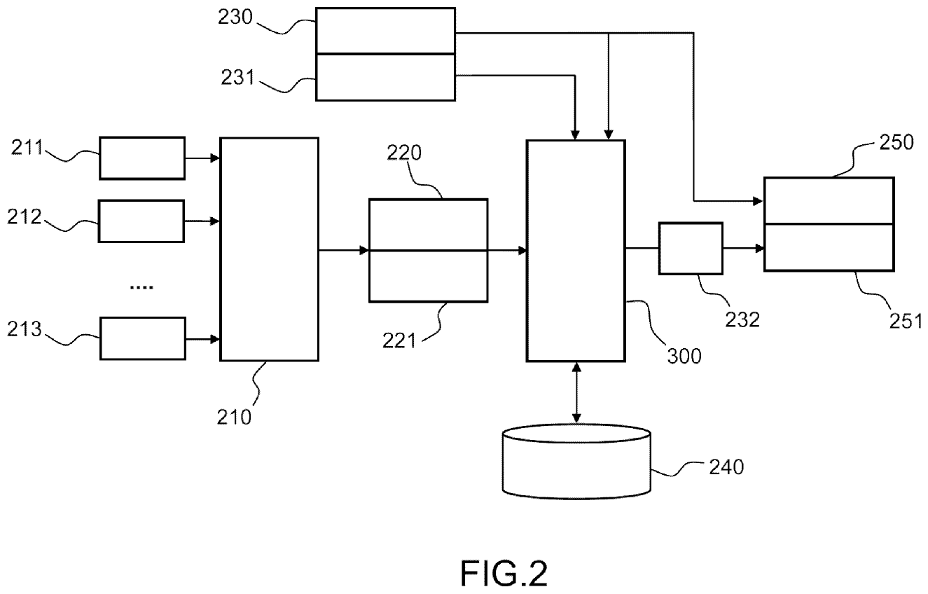

FIG. 2 shows a plurality of entities used by a computer-implemented method according to one set of embodiments of the invention.

The entities shown in FIG. 2 are used by a method implemented by a computer located on board an aircraft, for example by the FMS 100

A method according to the invention receives as input an estimated 3D position 220 of the aircraft, and at least one safety distance 221 defining, around the estimated position of the aircraft, a zone within which the actual position of the aircraft is located with a probability equal to or higher than a predefined threshold.

For example, the following elements may be received as input by the method according to the invention:
an estimated 3D position (latitude/longitude/altitude) of the aircraft, where appropriate composed of the combination:
   of an estimated 2D position (latitude/longitude) of the aircraft; and
   an estimated altitude of the aircraft;
a 95% probability estimation of the position error: the EPU for the horizontal position, and a VEPU for the vertical position;
a protection radius around the computed position: the HIL for a 2D position, and the VIL for altitude. HIL, also referred to as protection radius, is used to determine, around the estimated 2D position of the aircraft, a circle within which the true position of the aircraft is located with a given probability, and VIL makes it possible to determine, around the estimated altitude of the aircraft, a margin within which the true altitude of the aircraft is located with a given probability. These two values therefore allow a spatial zone within which the true 3D position of the aircraft is located, with a given probability, to be determined. Alternatively, a single protection radius, defining a sphere centered on the estimated 3D position of the aircraft, and within which the true 3D position of the aircraft is located with a given probability, may be provided. VIL and HIL therefore represent safety distances taking into account measurement uncertainties, and a desired probability that the distance between the estimated position and the true position of the aircraft is less than the safety distance.

The aircraft may comprise at least one sensor.

In one set of embodiments of the invention, a single-sensor solution may be used. For example, the aircraft may comprise a single sensor, for example a GNSS position sensor, that returns an estimated position of the aircraft, and the at least one distance.

In other embodiments of the invention, the estimated position of the aircraft, and the at least one distance are obtained via fusion of multi-sensor data from a plurality of sensors of the aircraft. In the example of FIG. 2, the position and the at least one distance are delivered by a multi-sensor location module 210, which determines position and the at least one distance based on measurements taken by a plurality of sensors 211, 212, 213 of the aircraft. Although 3 sensors have been shown in FIG. 2, the invention is not limited to this number of sensors, and a fusion of multi-sensor data may be obtained with any number of sensors higher than or equal to two.

The sensors may, for example, be all or some of the following sensors:
one or more GNSS position sensors;
one or more inertial sensors;
one or more vision-based position sensors;
one or more odometry-based position sensors;
one or more radio sensors able to estimate the position of the aircraft based on radio waves emitted by radio beacons;
etc.

Generally, the invention is applicable to any sensor able to return a position of the aircraft, or a quantity contributing to position estimation (e.g. speed, acceleration, rotation, etc.). Each sensor is able to provide a measurement, and a measurement uncertainty. For example, the accuracy of a GNSS position sensor depends on the number of satellites picked up by the GNSS receiver, and the quality of the signal received: the uncertainty associated with a GNSS position measurement will, for example, be much higher if the signal from 3 different satellites is received, than if the signal from 4 different satellites is received.

In one set of embodiments of the invention, only one of the measurements, generally the most accurate one, is selected. For example, the positions, altitudes and uncertainties may alternatively be obtained either based on GNSS measurements or based on beacon measurements, depending on which measurement is the most accurate in any given time interval.

In other embodiments, the measurements taken by the various sensors may be fused, for example via a Kalman filter, to obtain an overall estimated position of the aircraft, with an associated lateral and/or vertical uncertainty.

The use of a plurality of sensors makes it possible, in particular if the sensor data are fused, to obtain a more accurate position estimate.

In all cases, the at least one safety distance (HIL and/or VIL) represents a safety distance defined by the measurement uncertainties, making it possible to define, around an estimated position of the aircraft, a spatial zone within which the true position of the aircraft is located with a given probability.

A method according to the invention also receives as input a lateral path 230 of the aircraft, and a vertical flight profile 231 of the aircraft.

The lateral path 230 defines waypoints of the aircraft, from a point of departure to a point of arrival. Each waypoint may be defined by its coordinates (latitude, longitude). The waypoints may be formed by navigation beacons, or points defined specifically by their geographical coordinates.

The vertical flight profile defines the altitude of the aircraft depending on a distance to a point of departure or arrival. Coupled with the lateral path, it therefore allows a 3D path of the aircraft, defining a series of positions and altitudes, to be defined.

Lastly, the method according to the invention also receives as input a terrain and obstacle database 240. This database contains a definition of various obstacles that must be avoided by the aircraft. For example, it may comprise a terrain database, a definition of buildings, of prohibited or dangerous zones, etc. This database makes it possible to identify points at which it would be dangerous for the aircraft to be.

The method 300 according to the invention consists in detecting the possibility of a conflict between the predicted path of the aircraft, which is defined by the lateral path 230 and the vertical profile 231, which are assigned safety distances corresponding to the measurement uncertainties, and the terrain and obstacles obtained from the terrain and obstacle database 240; if a conflict is detected, the method 300 modifies the vertical flight profile in such a way as to increase the altitude of the waypoint of the aircraft at the location of the one or more detected conflicts, in order to avoid them. The aircraft may then follow the path, via lateral guidance 250 along the lateral path 230, and vertical guidance 251 along the modified vertical profile 232.

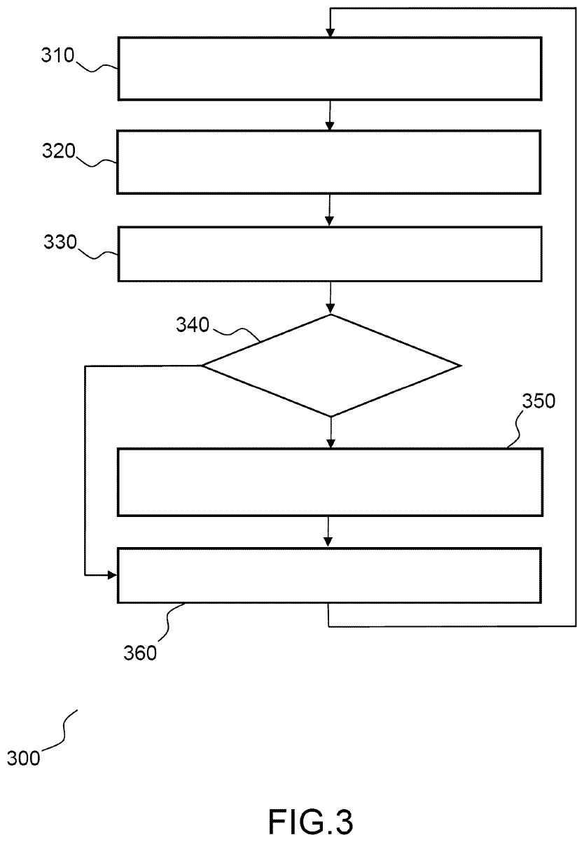

FIG. 3 shows one example of a computer-implemented method according to one set of embodiments of the invention.

The method 300 comprises a first step 310 of obtaining an estimated 3D position 220 of the aircraft, at least one safety distance 221 defining, around the estimated position of the aircraft, a zone within which the actual position of the aircraft is located with a probability equal to or higher than a predefined threshold, a lateral path 230 of the aircraft, a vertical flight profile 231 of the aircraft, and a terrain and obstacle database 240.

These various elements have been discussed with reference to FIG. 2.

The method 300 then comprises a second step 320 of determining a 3D flight corridor of the aircraft, taking into account the at least one safety distance around the lateral path and vertical profile.

The 3D corridor therefore corresponds to the set of positions at which the aircraft may be located at a given time while following its path, with a given probability.

The 3D corridor may be constructed in various ways. Generally, a predicted 3D path of the aircraft may be defined, based on the lateral path and on the vertical flight profile. Next, the at least one safety distance may be taken into account around the predicted 3D path, to define the 3D corridor.

This may be done in various ways.

In one set of embodiments of the invention, a single safety distance is defined around predicted aircraft positions. The 3D corridor may therefore be defined as a succession of cylinders defined around various path sections.

In other embodiments of the invention, two safety distances, or protection radii, may be defined:
a lateral safety distance, or HIL;
a vertical safety distance, or VIL.

In this case, the 3D corridor may be defined by successively applying each of the lateral and vertical safety distances to the predicted 3D path.

This therefore consists either in adding a lateral safety margin around the 3D path, then a vertical safety margin, or in adding a vertical safety margin around the 3D path, then a lateral safety margin. The path may then take the form of a series of parallelepipeds defined around successive path segments.

This solution has the advantage of being simple to implement. Detection of conflicts with the terrain and obstacle database is also facilitated, because it may be achieved by comparing altitudes on a 2D map.

Another solution allowing the 3D corridor to be determined consists in defining, based on the lateral and vertical safety distances, a safety ellipse around the predicted 3D path. The ellipse may be defined in such a way as to be centered on a predicted position of the aircraft, each of the axes of the ellipse corresponding to application of the horizontal safety distance, and to application of the vertical safety distance, on either side of the predicted position of the aircraft, respectively. The safety corridor may then take the form of a succession of elliptical cylinders having as axes the various segments of the 3D path.

The method then comprises a step 330 of projecting the 3D corridor onto the terrain and obstacle database, and a step 340 of verifying existence of a conflict between the 3D corridor and at least one obstacle of the terrain and obstacle database.

These steps consist in comparing the airspace zones forming part of the 3D corridor and the zones forming part of at least one obstacle of the database. When the 3D corridor at least partially intersects at least one obstacle, a conflict is detected: this means that there is a risk of the aircraft colliding with the obstacle.

According to various embodiments of the invention, these steps may be carried out in various ways.

For example, if the corridor is defined by parallelepipeds, i.e. with a vertical safety distance (VIL) and a horizontal safety distance (HIL), projection and verification may be carried out as follows: the vertical safety distance is subtracted from the aircraft altitude at each point on the 3D path, then the horizontal safety distance is applied around this modified 3D path. The result is a 2D map, each cell of which is a square between two latitudes and two longitudes, indicating whether the 3D corridor passes through each cell, and if so, the minimum altitude of the 3D corridor in this cell. This map may then be compared directly to a map of obstacles indicating a maximum altitude height of obstacles in each cell (i.e. reliefs, buildings, etc., a zone through which it is forbidden to fly potentially being represented by an obstacle of infinite height). If, in a cell, the minimum altitude of the corridor is less than or equal to the maximum obstacle altitude, a conflict is detected. This method has the advantage of being simple to implement.

A minimum altitude map may also be defined in various ways. For example, an ellipse the lengths of the axes of which are defined by the HIL and VIL may be drawn around each point of the 3D path, and the minimum altitude of the points of the ellipses noted in each cell of the map. This enables finer conflict detection.

The corridor and obstacles may also be noted in 3D maps, and conflict detection carried out in 3D rather than 2D.

Generally, the invention is not restricted to these detection methods, any method allowing a conflict to be detected between the 3D corridor representing the path of the aircraft, to which path one or more margins dependent on the uncertainty in the measurement of position have been added, and a terrain and obstacle database may be used.

If a conflict exists, the method 300 comprises a step 350 of modifying the vertical profile to increase the altitude of the aircraft at the location of said conflict.

This step consists in modifying the vertical profile to increase the altitude of the aircraft at the location of the conflict. For example, if the minimum altitude of the corridor is less by an altitude difference SH than the maximum altitude of an obstacle at a point where a conflict has been detected, this step consists in modifying the vertical profile locally, so that the altitude of the vertical profile at the point of conflict is increased by at least SH. Thus, the new 3D path and the new 3D corridor constructed based on the modified vertical profile will no longer be in conflict with this obstacle. By applying this method at each point of conflict, conflicts with all the obstacles in the database may be avoided.

This altitude modification may, for example, be achieved by increasing the altitude of a cruise phase, or by increasing the absolute value of the FPA during a climb or descent phase.

The method 300 then comprises a step 360 of guiding the aircraft according to the lateral path and the vertical profile.

This step consists in determining aircraft guidance commands allowing the lateral path and vertical profile to be followed, and in performing physical actions allowing this guidance to be followed (e.g. modification of engine thrust, of the state of flight actuators, etc.). This step may typically be carried out by the guidance module 190 and the autopilot 192.

The aircraft is guided according to the initially received lateral path, and either according to the initially received vertical profile if no conflict has been detected, or according to the vertical profile modified in step 350, if a conflict has been detected.

The method may be executed iteratively during flight. For example, the method 300 may be re-executed periodically, when the aircraft has advanced at least a predefined distance along the path, when the aircraft has reached a predefined position (for example predefined positions for the re-computation may be sampled along the path), or on the occurrence of events such as a decrease in the accuracy of the position measurements, or a deviation of the aircraft from its path. Thus, the vertical profile of the aircraft will potentially be modified, in real time, as many times as necessary for the aircraft to remain safe throughout its flight.

The method according to the invention thus allows a lateral path to be followed while ensuring that there is no risk of collision with a given probability. Specifically, the dimensions of the safety corridor depend on the one or more safety distances, which may be defined to ensure, depending on measurement accuracy, that the true position of the aircraft is, at any given time, located within the corridor with a probability at least equal to a safety threshold.

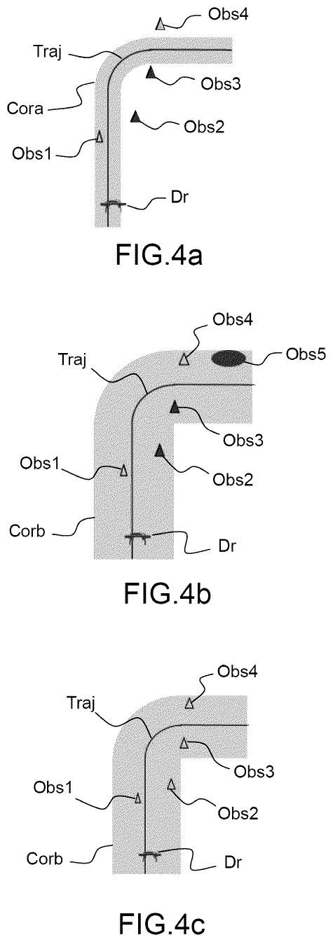

FIG. 4a shows one example of a 3D safety corridor, in one set of modes of implementation of the invention.

FIG. 4b shows one example of increase in the size of a 3D safety corridor, following deterioration of a GNSS signal according to one set of embodiments of the invention.

FIG. 4c shows one example of achieving safety through modification of a 3D safety corridor, by modifying a vertical flight profile, in one set of embodiments of the invention.

FIGS. 4a, 4b and 4c in fact show three successive steps of the same scenario, in which:
in FIG. 4a, an initial 3D safety corridor does not conflict with obstacles;
in FIG. 4b, following deterioration of measurement reliability, the 3D corridor is enlarged, and conflicts appear with certain obstacles;
in FIG. 4c, applying the method 300 and increasing the altitude of the vertical profile level with some obstacles allows conflicts to be avoided, while preserving the initial lateral path.

In the example of FIGS. 4a, 4b and 4c, the aircraft is a drone, denoted Dr. Obstacles the altitude of which is less than the corresponding altitude of the 3D corridor have been represented by hollow shapes. These obstacles are therefore not problematic. Obstacles the altitude of which is greater than or equal to the corresponding altitude of the 3D corridor have been represented by solid shapes. In case of intersection with the 3D corridor, a conflict is identified.

In FIG. 4a, a 3D safety corridor Cora is defined around the lateral path Traj. Four obstacles are present in the immediate environment of the path:
a first obstacle Obs1, located under the corridor Cora but at a lower altitude: this obstacle therefore generates no conflict;
a second obstacle Obs2, located at an altitude higher than the closest minimum altitude of the corridor Cora, but at a lateral location outside the corridor: this obstacle therefore generates no conflict;
a third obstacle Obs3, located at an altitude higher than the closest minimum altitude of the corridor Cora, but at a lateral location outside the corridor: this obstacle therefore generates no conflict;
a fourth obstacle Obs4 located at a lateral location outside the corridor, and at a lower altitude: this obstacle therefore generates no conflict.

At this stage, no conflict is therefore detected.

Next, in FIG. 4b, the accuracy of the location of the drone decreases. This may for example happen if the GNSS receiver loses a satellite. As a result, the lateral safety margin, or protection radius HIL increases: a new 3D safety corridor Corb around the path is defined. The obstacles Obs1 and Obs4 still do not generate any conflict, because their altitude is less than the minimum altitude of the 3D corridor at their location.

In contrast, the obstacles Obs2 and Obs3 are now located at a lateral location that intersects the 3D corridor, and, since their altitude is greater than the minimum altitude of the 3D corridor Corb at this location, they each generate a conflict. A fifth obstacle Obs5 has also entered into conflict with the corridor.

In FIG. 4c, step 350 is activated: the vertical profile is modified, increasing the altitude of the drone level with obstacles Obs2, Obs3 and Obs5, the lateral path and safety margins remaining identical. This allows the predicted altitude of the drone level with these obstacles to be sufficient to no longer conflict with these three obstacles.

This example demonstrates the ability of the invention to allow an aircraft to follow a lateral path while meeting a determined and deterministic safety level with respect to a set of obstacles.

The above examples demonstrate the ability of the invention to allow an aircraft to follow a lateral path while ensuring a determined safety level with respect to obstacles, depending on the accuracy of sensor measurements received by the aircraft. However, they are given merely by way of example and in no way limit the scope of the invention as defined in the claims below.

1. A method implemented by a computer located on board an aircraft, comprising:
obtaining an estimated 3D position of the aircraft, at least one safety distance defining, around the estimated position of the aircraft, a zone within which the actual position of the aircraft is located with a probability equal to or higher than a predefined threshold, a lateral path of the aircraft, a vertical flight profile of the aircraft, and a terrain and obstacle database;
determining a 3D flight corridor of the aircraft, taking into account the at least one safety distance around the lateral path and vertical profile;
projecting said 3D corridor onto the terrain and obstacle database;
verifying existence of a conflict between the 3D corridor and at least one obstacle of the terrain and obstacle database;
if a conflict exists, modifying the vertical profile to increase the altitude of the aircraft at the location of said conflict;
guiding the aircraft according to the lateral path and the vertical profile.

2. The method as claimed in claim 1, wherein the estimated position of the aircraft, and the at least one distance are obtained via fusion of multi-sensor data from a plurality of sensors of the aircraft.

3. The method as claimed in claim 2, wherein the fusion of multi-sensor data employs a Kalman filter.

4. The method as claimed in claim 1, wherein the at least one safety distance comprises a lateral safety distance, and a vertical safety distance.

5. The method as claimed in claim 4, wherein determining the 3D corridor consists in predicting a 3D path of the aircraft based on the lateral path and on the vertical profile, and then in successively adding each of the lateral and vertical safety distances to the 3D path.

6. The method as claimed in claim 4, wherein determining the 3D corridor consists in predicting a 3D path of the aircraft based on the lateral path and on the vertical profile, defining a safety ellipse based on the lateral and vertical safety distances, then in adding the safety ellipse to the 3D path.

7. The method as claimed in claim 1, wherein modifying the vertical profile consists in increasing the altitude of the aircraft by an altitude difference (δH) between the altitude of the at least one obstacle and the minimum altitude of the 3D corridor at the location of said conflict.

8. A computer program comprising program-code instructions stored on a computer-readable medium, said program-code instructions being configured, when said program is run on a computer, to execute a method as claimed in claim 1.

9. A flight management system for an aircraft, comprising computing means configured to execute a method as claimed in claim 1.
